(19) United States
(12) Patent Application Publication
(10) Pub. No.: US 2021/0398031 A1
(43) Pub. Date: Dec. 23, 2021

(54) SYSTEMS AND METHODS FOR PROVIDING A TONE-BASED SERVICE

(71) Applicant: Nicholas-Alexander, LLC, Las Vegas, NV (US)

(72) Inventor: Thomas Webster, Las Vegas, NV (US)

(21) Appl. No.: 17/349,977

(22) Filed: Jun. 17, 2021

Related U.S. Application Data
(60) Provisional application No. 63/040,288, filed on Jun. 17, 2020.

(51) Int. Cl. G06Q 10/02; H04B 11/00

(52) U.S. Cl. CPC G06Q 10/02; H04B 11/00

(57) ABSTRACT

Embodiments provided herein include systems and methods for providing a tone-based service. Some embodiments include receiving reservation data for a patron at an establishment and receiving a first tone from a first mobile device of the patron. The first tone may be non-naturally occurring and human imperceptible, where the first tone includes data that identifies the patron and the reservation. These embodiments may further include determining whether the reservation includes at least one other patron, determining whether a second tone has been received from a second mobile device associated with the at least one other patron indicating the at least one other patron is present at the establishment. In response to determining that the at least one other patron is not present at the establishment, embodiments include providing a message to the patron that other members of the reservation have not yet arrived.

### CROSS REFERENCE

This application claims the benefit of U.S. provisional application Ser. No. 63/040,288, entitled Systems and Methods for Providing a Tone-Based Service, filed on Jun. 17, 2020, which is hereby incorporated by reference in its entirety.

### TECHNICAL FIELD

Embodiments described herein generally relate to systems and methods for providing a tone-based service and, more specifically, to embodiments for providing a tone-based service for restaurant, retail, and/or other service based establishments.

### BACKGROUND

Currently, many restaurants distribute devices that notify a restaurant patron when a table becomes available. Specifically, when the patron arrives at the restaurant, he/she may need to wait for a table to become available. In order to easily locate and notify the patron when that occurs, a device may be loaned to the patron that vibrates, lights, and/or otherwise actuates to notify the patron. Some restaurants simply accept the patron's mobile telephone number and text the patron when the table becomes available.

While these current solutions improve the ability for the restaurant notify a patron when a table is ready, these solutions have the drawback of only being able to communicate binary data (ready/not ready) to the patron. Additionally, when the restaurants distribute community-shared devices, there is a possibility that germs will spread among patrons. Further, those solutions that simply text the patron when the table is ready often fail when mobile service at the restaurant is less than optimal. As such, a need exists in the industry for providing a tone-based service.

### SUMMARY

Embodiments provided herein include systems and methods for providing a tone-based service. Some embodiments include receiving reservation data for a patron at an establishment and receiving a first tone from a first mobile device of the patron. The first tone may be non-naturally occurring and human imperceptible, where the first tone includes data that identifies the patron and the reservation. These embodiments may further include determining whether the reservation includes at least one other patron, determining whether a second tone has been received from a second mobile device associated with the at least one other patron indicating the at least one other patron is present at the establishment. In response to determining that the at least one other patron is not present at the establishment, embodiments include providing a message to the patron that other members of the reservation have not yet arrived.

Embodiments of a system include a plurality of tone-based communication devices that each include a speaker and/or a microphone, where the plurality of tone based communication devices communicate data by broadcasting non-naturally occurring and human imperceptible tones. The system may also include an establishment device that includes a memory component and a processor, where the memory component stores logic that, when executed by the processor, causes the system to receive reservation data for a patron at an establishment and receive, via at least one of the plurality of tone-based communication devices, a first tone from a first mobile device of the patron, where the first tone includes data that identifies the patron and the reservation. The logic may also cause the system to determine whether the reservation includes at least one other patron, determine whether a second tone has been received, via at least one of the plurality of tone-based communication devices, from a second mobile device associated with the at least one other patron indicating the at least one other patron is present at the establishment. In response to determining that the at least one other patron is present at the establishment, receive third tones from at least three of the plurality of tone-based communication devices, calculate from the third tones, a location of the second mobile device, and provide information related to the location of the second mobile device. In some embodiments, the logic further causes the system, in response to determining that the at least one other patron is not present at the establishment, to communicate a message to the patron that other members of the reservation have not yet arrived.

Embodiments of a computing device include logic that when executed by a processor of the computing device, causes the computing device to receive reservation data for a patron at an establishment, receive, from a first tone-based communication device, a first tone from a first mobile device of the patron, wherein the first tone includes data that identifies the patron and the reservation, determine whether the reservation includes at least one other patron, and determine whether a second tone has been received from a second tone-based communication device, associated with a second mobile device of at least one other patron indicating the at least one other patron is present at the establishment. In some embodiments, the logic may cause the computing device, in response to determining that the at least one other patron is present at the establishment to calculate from tones created by the second mobile device, a location of the second mobile device and provide information related to the location of the second mobile device. In some embodiments, in response to determining that the at least one other patron is not present at the establishment, the logic may cause the system to communicate a message to the patron that other members of the reservation have not yet arrived.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for providing a tone-based service, according to embodiments described herein;

FIG. 2 depicts a service establishment for providing a tone based service, according to embodiments provided herein;

FIG. 3 depicts a user interface for a patron who made a reservation at a service establishment, according to embodiments provided herein;

FIG. 4 depicts a user interface for a patron whose contact made a reservation at a service establishment, according to embodiments provided herein;

FIG. 5 depicts a user interface for a patron who does not have a reservation at a service establishment, according to embodiments provided herein;

FIG. 6 depicts a user interface of a patron who wishes to reserve a table without a reservation, according to embodiments provided herein;

FIG. 7 depicts a user interface for a patron to place an order prior to being seated, according to embodiments provided herein;

FIG. 8 depicts a user interface for notifying a patron that another person in the party has arrived at the service establishment, according to embodiments provided herein;

FIG. 9 depicts a user interface for notifying a patron that the party's table is ready, according to embodiments provided herein;

FIG. 10 depicts a user interface for a patron to utilize once seated at the table, according to embodiments provided herein;

FIG. 11 depicts an establishment interface for providing information regarding the service establishment, according to embodiments provided herein;

FIG. 12 depicts an establishment interface for providing information regarding a patron, according to embodiments provided herein;

FIG. 13 depicts an establishment interface for providing information regarding a table in an establishment, according to embodiments provided herein;

FIG. 14 depicts an establishment interface for providing information related to a kitchen queue and a bar queue, according to embodiments provided herein;

FIG. 15 depicts a flowchart for providing service reminders to restaurant staff, according to embodiments described herein;

FIG. 16 depicts a flowchart for providing an option to a patron to order food, according to embodiments described herein;

FIG. 17 depicts a flowchart for providing a tone based service, according to embodiments provided herein;

FIG. 18 depicts components of a remote computing device, according to embodiments described herein.

### DETAILED DESCRIPTION

Embodiments disclosed herein include systems and methods for providing a tone-based service. Some embodiments may be configured such that a restaurant or other service establishment has one or more tone-based communication devices on premises. The tone-based communication device may be configured to send and/or receive non-naturally occurring audio tones (or tone pairs) that are imperceptible by a human due to the frequency, the volume, and/or for other reasons. As a patron enters a service establishment (such as a restaurant, bar, movie theatre, fitness center, etc.), the patron's mobile device may be configured to receive the tones, decipher the message embedded in the tones, and create its own tone-based messages that may be received and deciphered by other tone-based communication devices at the service establishment.

These embodiments may allow a user to enter the service establishment and the tone-based communication devices may be broadcasting a welcome tone that is received by the patron's mobile device. The patron's mobile device may provide one or more user interfaces associated with the data provided. In some embodiments, the patron's mobile device may utilize location-based services (such as GPS) on the mobile device to determine that the user is currently located in “Jordan's Deli.” With that information, the mobile device that is equipped with tone-based hardware for receiving and/or sending non-naturally occurring tones described herein may receive tones from Jordan's Deli; decode the data embedded within the tones, which may open a website for providing functionality described herein. In these embodiments, the tones communicated between the tone-based communication devices in Jordan's Deli and the mobile device may be used to populate the webpage on the mobile device, which is then communicated with the remote computing device.

In some embodiments however, the actual data communicated via the tones from Jordan's Deli may actually create a peer-to-peer communication portal between the tone-based communication device and the mobile device. In these embodiments, the mobile device may enter Jordan's Deli and receive the non-naturally occurring tones. The data embedded within these tones may actually instruct the mobile device to create the user interfaces provided herein without use of the internet, mobile network, Wi-Fi, or other third party network. This allows for an encrypted peer-to-peer communication. An establishment device may communicate at least a portion of the data to a remote computing device for storage and later retrieval, again on an encrypted linen that the establishment controls. These embodiments may provide enhances data security and reliability.

Regardless, in embodiments where the service establishment is a restaurant, the welcome message may include an option for the patron to check-in. The patron may check-in; thereby informing the restaurant that he/she has arrived. A menu and/or ordering options may be provided to the patron. The patron's location within establishment may be determined based on communication of the tones. In some embodiments, the tone-based communication devices may broadcast tones with a timestamp. When the mobile device has received tones from three (or more) tone-based communication devices, the mobile device may determine its location within the establishment based on a triangulation of the time it took for the tones to reach the mobile device. In some embodiments, the tone-based communication devices may communicate tones with intensity data (such as a loudness metric). The mobile device may determine its location by determining the received intensity and comparing with the broadcast intensity. Using tones from three or more tone-based communication devices, the mobile device may determine its location within the service establishment.

In some embodiments, the mobile device may broadcast the tones and the tone-based communication devices may receive the tones. Based on a timestamp, intensity data, and/or other data, three or more of the tone-based communication devices may communicate with an establishment device that may determine the location of the mobile device. Thus in any of these embodiments, if it is determined that the patron is located at the bar, a drink menu may be automatically provided with an option to order. As the mobile device has already registered for the meal, the drink charge may be added to the meal charges once the meal is complete.

Some embodiments may also be configured for estimating a time that a table will be available, based on position of other patron's user devices, estimated preparation time for meals ordered by the other patrons, drink orders by the other patrons, historical data associated with a mobile device, and/or other information communicated between the patrons' mobile devices and the tone-based communication devices. In these embodiments, a collection of mobile devices may be eating at a table. The establishment device may collect data not only regarding the current order, but also historical data associated with those patrons, including average time at a table, average time the patrons will leave, whether the patrons typically order dessert or coffee. With this information, these embodiments may calculate a probability regarding what these patrons will order, the time it will take to prepare the order, and the time after service is completed that the patrons will leave. With this information, the establishment device can predict a time that the table will be available. This prediction may be updated, as the patrons order additional items or complete the transaction.

As another example, as the patron approaches an establishment, the mobile device presents a welcome message and an opportunity to reserve a table or check-in. While waiting to be seated, the mobile device may offer an opportunity to order a beverage to be delivered to them. The mobile device may automatically initiate the order process complete payment or keep the order open for additional purchases. While the beverage order is delivered to the patron and payment is being finalized, the mobile device may display a custom message to the patron.

When the table is ready, the patron is prompted on the mobile device to be seated. The establishment device alerts the employee to refill the patron's beverage. The patron may also be provided with an option to pre-order food so that the food arrives at the table as the patron is being seated. Some embodiments of the establishment device may include one or more mobile devices that employees may utilize. Throughout the meal, the mobile device can offer specials, advertisements, add-ons, etc. to the patron's order. Payment may be finalized directly through the mobile device. The establishment may continue marketing to the patron after the patron has left the establishment. The systems and methods for providing a tone-based service incorporating the same will be described in more detail, below.

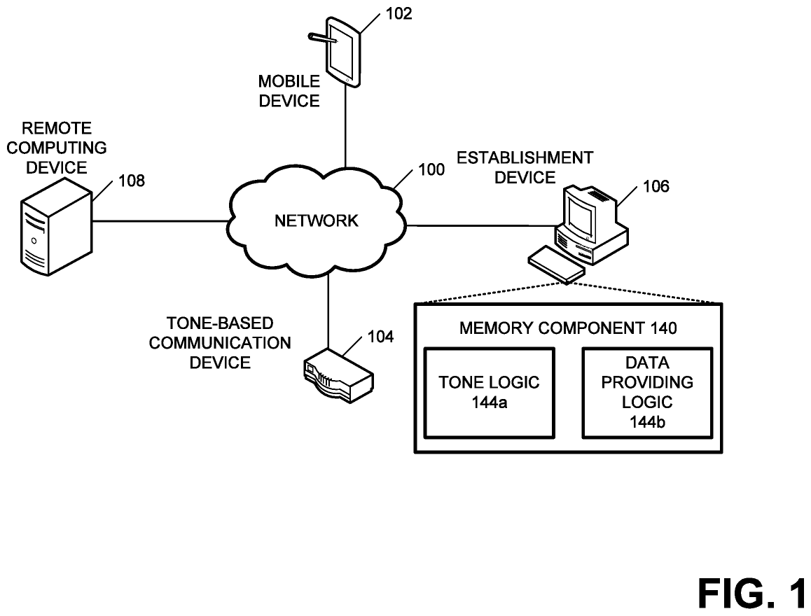

Referring now to the drawings, FIG. 1 depicts a computing environment for providing a tone-based service, according to embodiments described herein. As illustrated, the computing environment may include a network 100, which may include a wide area network (wired or wireless), such as the internet, a cellular network, or other communications network for communicating devices across a wide area. Similarly, the network 100 may include a wired or wireless local area network for communicating data, including tone-based and/or other peer-to-peer network communications, as described herein.

Coupled to the network 100 are a mobile device 102, a tone-based communication device 104, an establishment device 106, and a remote computing device 108. The mobile device 102 may be configured for a user to make reservations prior to the patron reaching the establishment, and thus is configured to communicate via a wide area network. Additionally, the mobile device 102 may be configured for tone-based communications when the patron has arrived at the establishment, and thus may include a speaker, a microphone, as well as other hardware and software for generating, receiving, encrypting, decrypting, and interpreting the non-naturally occurring inaudible tones described herein. As such, the mobile device 102 may represent a personal computer, tablet, mobile device, and/or other device for a patron to communicate with the tone-based communication device 104 and/or the remote computing device 108, as described in more detail below.

Also included is the tone-based communication device 104. The tone-based communication device 104 may represent one or more devices positioned in proximity to the establishment for communicating tone-based data with the mobile device 102. Depending on the particular embodiment, the tone-based communication device 104 may be configured simply as a speaker and/or microphone for the remote computing device 108 or establishment device 106 to control or may be its own computing device in a mesh-like network of tone-based communication devices 104. Regardless, the tone-based communication device 104 may include a speaker, microphone, and/or other hardware and/or software for communicating with the mobile device 102, the establishment device 106, and/or the remote computing device 108, as described in more detail below.

The establishment device 106 may be configured as a personal computer, tablet, mobile device, and/or other device for entering reservations, creating messages for communication via the tone-based communication device 104, receiving payments, providing advertisements, and/or providing other functionality for the establishment. As such, the establishment device 106 may include a memory component 140 that stores tone logic 144a and data providing logic 144b. The tone logic 144a may include one or more components, such as for generating one or more tones. In some embodiments, the establishment device 106 is distinct from the remote computing device 108; however, some embodiments are configured such that at least a portion of the components and/or functionality of the establishment device 106 and the remote computing device 108 are combined.

Depending on the embodiment, the tones may be integrated into content, such as audio content, audio/video content, etc. that may be presented in the establishment. As an example, while some embodiments may broadcast tones independent of other content, some embodiments may utilize the tone-based communication devices 104 as speakers to broadcast music throughout the establishment. The tone-based communication device 104 (and/or other device provided herein) may embed the tones within the music and broadcast together. The data providing logic 144b may be configured to cause the establishment device 106 to provide the tone data to the tone-based communication device 104. The data providing logic 144b may further cause the remote computing device 108 to communicate with the establishment device 106 for creation and/or management of the tone data.

The remote computing device 108 may be configured as a server, personal computer, tablet, mobile device, and/or other device. The remote computing device may be configured for receiving, storing and/or processing data as a remote device, as described herein.

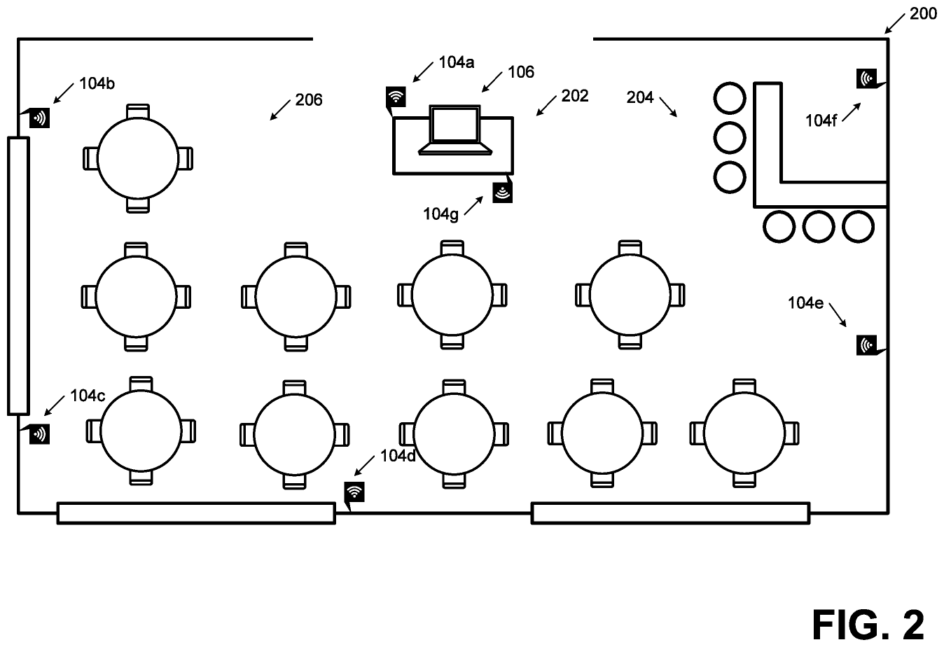

FIG. 2 depicts a service establishment 200 for providing a tone-based service, according to embodiments provided herein. As illustrated, the service establishment 200 may be configured as a restaurant, a bar, a fitness center, a movie theatre, and/or other services-based establishment. The service establishment 200 may include a welcome area 202, a bar area 204, and a table area 206. The service establishment 200 may additionally include the establishment device 106, as well as a plurality of tone-based communication devices 104a-104g, which may broadcast non-naturally occurring tone pairs, as described herein.

It will be understood that while FIG. 2 depicts seven tone-based communication devices 104, this is merely an example. Depending on the size of the establishment, the number of patrons, the number of interior walls, etc., the number of tone-based communication devices 104 may vary.

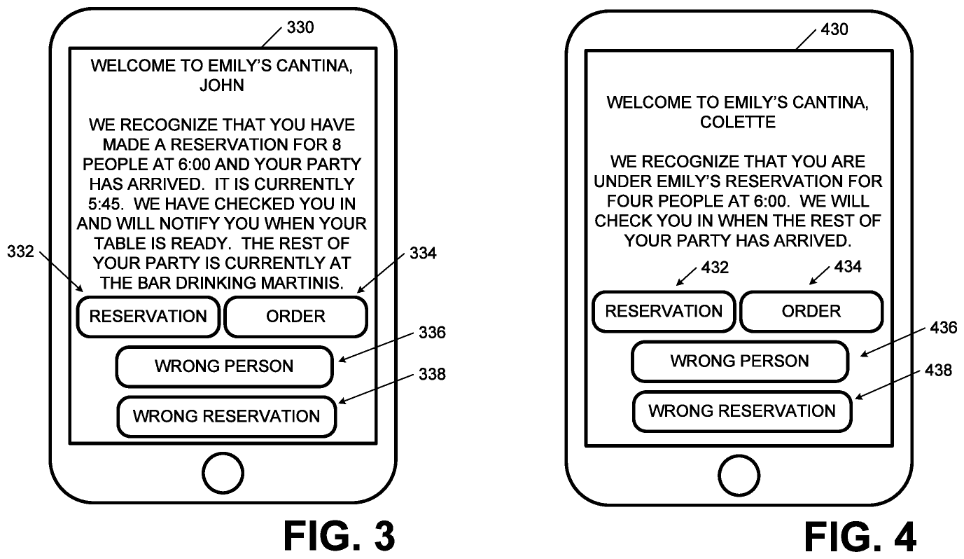

FIG. 3 depicts a user interface 330 for a patron who made a reservation at a service establishment 200, according to embodiments provided herein. As illustrated, the user interface 330 may provide information regarding the patron and the patron's reservation. Specifically, the patron may have made a reservation online (or over the phone) and indicated an identifier of the other individuals in the reservation. As a result, as each member of the party arrives, embodiments provided herein may communicate tones with the associated devices to determine which individuals have arrived. Instructions may be provided to the individuals who arrive regarding a location of the bar, the restroom, the other members of the party, and/or other information.

As such, the embodiment of FIG. 3 has already determined that the other members of the reservation have arrived and thus the entire party may be seated. It will be understood that the particular establishment may indicate whether to allow each individual to be seated when they arrive; to only permit seating when the reserving party has arrived; and/or to only permit seating when the entire party has arrived. In the embodiment of FIG. 3, while the entire party has arrived, the table is not yet ready. The mobile device 102 also determines (such as from establishment device 106 and/or via other mechanism) that the other members of the party have begun ordering drinks and provides such information in the user interface 330.

The user interface 330 also provides a reservation option 332, an order option 334, a wrong person option 336, and a wrong reservation option 338. In response to selecting the reservation option 332, the patron may view and/or edit the previously created reservation. In response to selection of the order option 334, the patron may view the menu and may place the order on the mobile device 102. It should be understood that while the order may be brought to the patron's location, the patron may specify that the order be delivered to a specific location and/or to another patron in the service establishment 200.

In response to selection of the wrong person option 336, the patron may identify that an error has occurred and he/she is not the patron identified. In response to selection of the wrong reservation option 338, the patron may indicate that while they are the correct person, the reservation is not correct.

It should be noted that other options may be provided as well, such as an option to locate the individuals who have arrived and/or an option to route the patron to those other people. This allows the patron to easily find the other members of the reservation without significant difficulty.

FIG. 4 depicts a user interface 430 for a patron whose contact made a reservation at a service establishment 200, according to embodiments provided herein. As illustrated, while the user interface 330 depicts a situation where the party has arrived, the user interface 430 depicts a situation where a party to a reservation has arrived, but the rest of the party has not. As such, the party may not check in, until the rest of the party arrives. Also provided in the user interface 430 is a reservation option 432, an order option 434, a wrong person option 436, and a wrong reservation option 438.

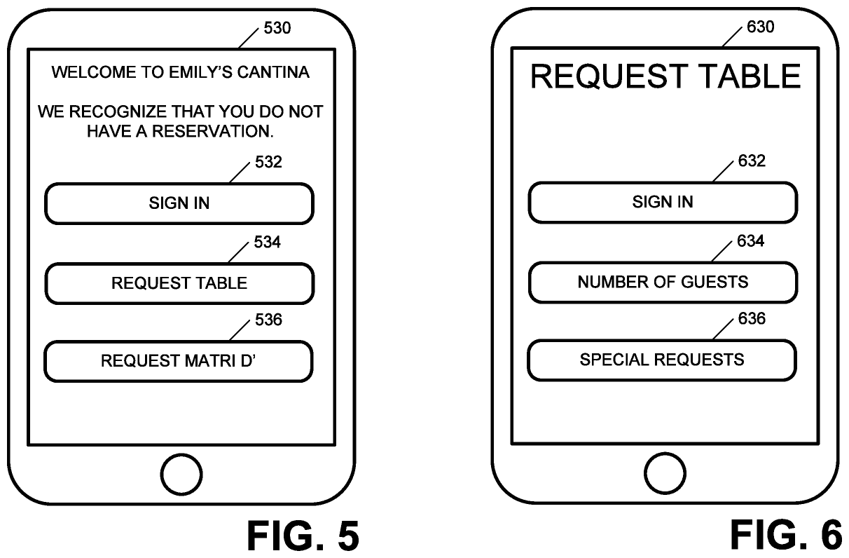

FIG. 5 depicts a user interface 530 for a patron who does not have a reservation at a service establishment 200, according to embodiments provided herein. As illustrated, the user interface 530 allows a patron to arrive at an establishment without a reservation and still be served. Accordingly, a sign in option 532, a request table option 534, and a request maître d' option 536 may be provided. In embodiments where the patron's identity is known, the sign in option 532 may be disabled. If the patron's identity is not known, in response to selection of the sign in option 532, additional options and/or fields may be provided for the user to register and/or sign into an existing account.

In response to the request table option 534, the patron may essentially make a reservation for the next available table that meets the patrons requests (e.g., number of seats, at the bar, etc.). In response to selection of the request maître d' option 536, a maître d', host, hostess, and/or other staff member may be notified that the patron needs assistance. Specifically, while the service establishment 200 (FIG. 2) may have a staff member at the welcome area 202, other establishments may not keep a person in this area unless requested.

FIG. 6 depicts a user interface 630 of a patron who wishes to reserve a table without a reservation, according to embodiments provided herein. In response to selection of the request table option 534 from FIG. 5, the user interface 630 may be provided. The user interface 630 provides a sign in option 632, a number of guests option 634, and a special requests option 636. Similar to the sign in option 532 from FIG. 5, the sign in option 632 may provide options and/or fields for signing in or registering an account. In response to selection of the number of guests option 634, the patron may specify how many people are in the party. In response to selection of the special requests option 636, the patron may specify other requests, such a location of a table, a booth/table, a time to be seated (if not now), etc.

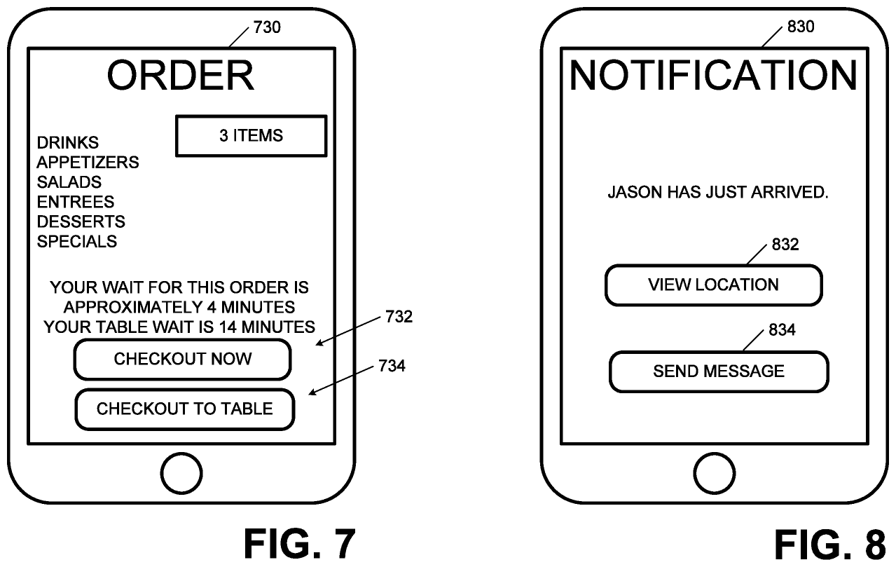

FIG. 7 depicts a user interface 730 for a patron to place an order prior to being seated, according to embodiments provided herein. In response to selection of the order option 334 (FIG. 3) or 434 (FIG. 4), the user interface 730 may be provided. It should be noted that the user interface 730 may be provided prior to the patrons being seated. Accordingly, the menu may be provided in the user interface 730. The user may select one or more menu items to view and/or purchase. Embodiments may determine the approximate wait time for the items, as well as the current approximate wait time for the table. The wait time for the order may be predicted from a current kitchen queue and/or bar queue, a predicted preparation time, a predicted cook time, and/or other factors. If the patron orders several items, the wait time may be predicted based on the item that takes longest to prepare. As discussed herein the wait time may also be predicted.

If the order time is less than the table wait time, a checkout now option 732 and a checkout to table option 734 may be provided. In response to selection of the checkout now option 732, the patron is essentially placing the order for immediate delivery to the patron (wherever the patron is at that time). In response to selection of the checkout to table option 734, the user may be placing the order such that (if possible) the item arrives at the table around the time the table is ready. If the table wait time is less than the order wait time, the options may be disabled, as it is assumed the patron will be at the table when the order is ready.

FIG. 8 depicts a user interface 830 for notifying a patron that another person in the party has arrived at the service establishment 200, according to embodiments provided herein. As illustrated, the user interface 830 may provide a notification when another person in the party has arrived, so that the patron may be on the lookout for that person. Also provided are a view location option 832 and a send message option 834. In response to selection of the view location option 832, the location of “Jason” may be provided. As described above, the location may be identified via Jason's mobile device 102 sending and/or receiving tones with the tone-based communication device 104. This location may be sent from Jason's mobile device 102 to the tone-based communication device 104 and then broadcasted as an encrypted message to the patron's mobile device 102.

Similarly, in response to selection of the send message option 834, a user interface for sending a message to Jason is provided. While a traditional SMS or email type message may be sent, some embodiments provide that the patron may send a tone-based message to Jason. Specifically, the patron may type a message, which is encrypted and broadcast to one or more tone-based communication device 104. The tone-based communication device 104 may then broadcast the message to Jason's mobile device 102, which decrypts the message and provides to Jason.

It should be understood that because a plurality of tones may be broadcast simultaneously, a plurality of devices in the vicinity may be capable of intercepting a tone. As such, at least a portion of the tones may be encrypted. To facilitate such encrypted communication, when a patron creates a reservation or otherwise utilizes the platform, an encryption key may be created for that patron and/or for the other members of the party. Depending on the embodiment, a user may have a plurality of unique encryption keys for separate communications with other devices and/or groups of devices. As such, when a mobile device 102 receives a tone, the mobile device 102 may utilize the encryption keys available to that mobile device 102 and discard any message that cannot be decrypted via one of those keys.

Additionally, as there might be a plurality of tones being broadcast in a location simultaneously, different frequencies may be utilized to reduce interference among broadcast tones. As an example, along with an encryption key, a frequency may be common for each connection during a stay at the service establishment 200 (FIG. 2). In some embodiments, tones may be determined on the fly based on frequencies being broadcast at that particular time. In some embodiments, a blockchain or other public or private ledger may be utilized to ensure that a frequency is not being used for two separate communications at any one time.

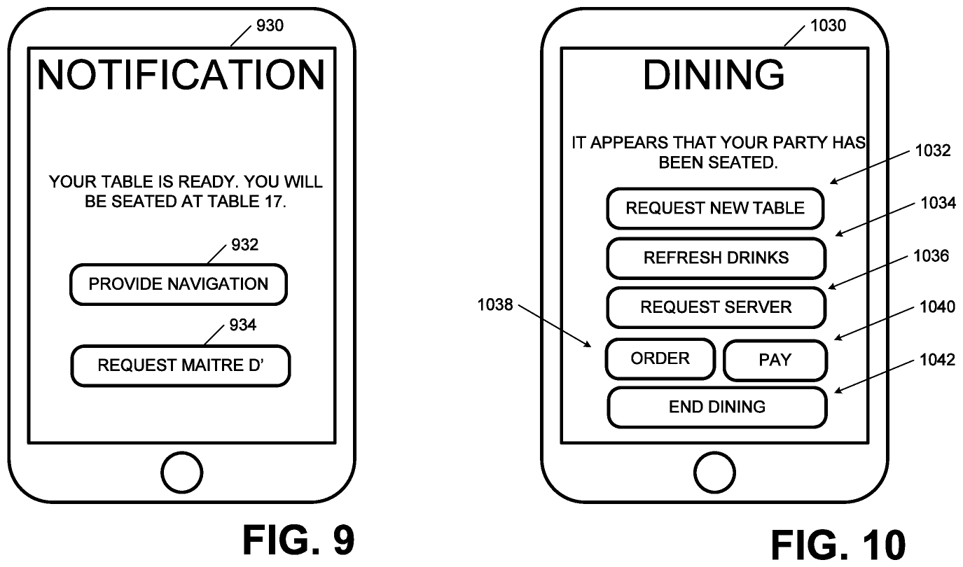

FIG. 9 depicts a user interface 930 for notifying a patron that the party's table is ready, according to embodiments provided herein. As illustrated, the user interface 930 may provide the patron with a notification that a table is ready and which table. A navigation option 932 and a request maître d' option 934 may also be provided.

FIG. 10 depicts a user interface 1030 for a patron to utilize once seated at the table, according to embodiments provided herein. As illustrated, once the patron has been seated the mobile device 102 may provide the user interface 1030. The user interface 1030 may include a request new table option 1032, a refresh drinks option 1034, a request server option 1036, an order option 1038, a pay option 1040, and an end dining option 1042.

In response to selection of the request new table option 1032, the patron may request that his/her party be reseated. In response to selection of the refresh drinks option 1034, a notification may be sent to a server and/or staff member to refresh the drinks, bread, chips, etc. In response to selection of the request server option 1036, the server may be notified to approach the table. In response to selection of the order option 1038, a menu and ordering options may be provided. In response to selection of the pay option 1040, payment options may be provided. As an example, if each member of the party ordered their own food, each may pay themselves. However, options may be provided for another patron to purchase at least a portion of an item someone else ordered. As an example, if one patron desires to purchase the appetizer, another patron may request that the appetizer be added to his/her bill instead. Similarly, if the appetizer was $10, the group of patrons may decide to divide that cost evenly.

In situations where a single patron ordered all the items, options may be provided to divide out the items (or charges) among two or more members of the party. Similarly, if the members desire to play “credit card roulette,” where a randomly selected person pays the entire bill, all members who are participating may be provided with an option to agree.

In response to selection of the end dining option 1042, a notification may be sent to the server and/or other staff member that no more service is desired and that the party will be leaving shortly. In response, the staff may begin cleaning the table.

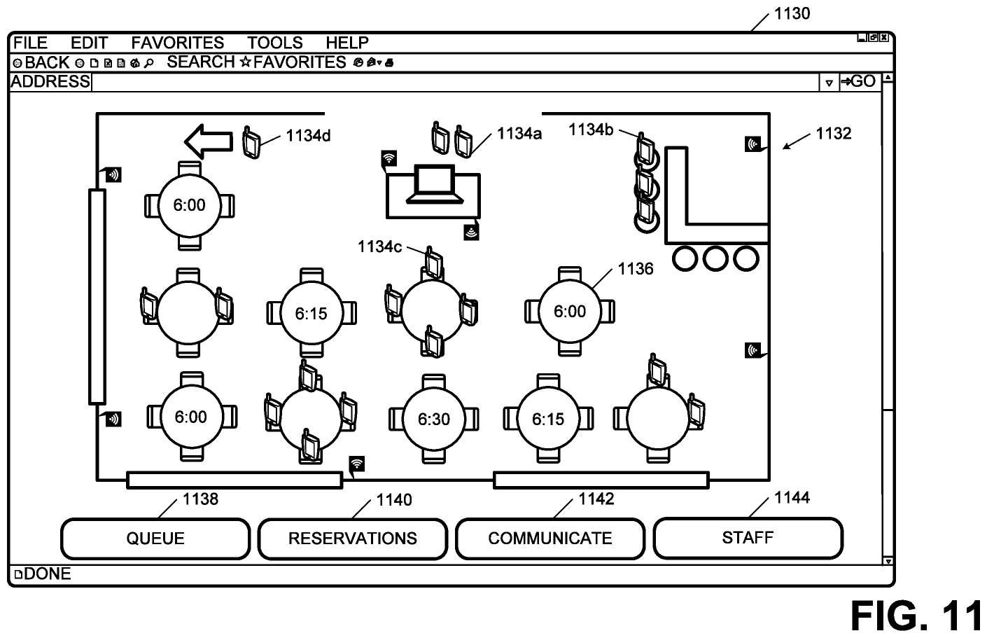

FIG. 11 depicts an establishment interface 1130 for providing information regarding the service establishment 200, according to embodiments provided herein. Specifically, while a patron may receive and/or interact with the user interfaces from FIGS. 3-10, the establishment interface 1130 is provided to a staff member of the service with a recreation 1132 of establishment 200 (FIG. 2), such as via the establishment device 106. Accordingly, the establishment interface 1130 provides a visual depiction of the service establishment 200, as well as a location of at least a portion of patrons whose mobile devices are detected by the tone-based communication devices 104. As an example, an icon 1134 may be provided to show that a patron has entered the service establishment 200 and is currently at the welcome area 202. An icon 1134b may illustrate that a patron is located at the bar area 204. An icon 1134c may be provided to illustrate that a patron is located in the table area 206. An icon 1134d may be coupled with a vector to illustrate a direction of movement of a patron. A table 1136, plurality of tables, and/or other areas of the service establishment 200 may also be provided.

Also provided in the establishment interface 1130 are a queue option 1138, a reservations option 1140, a communicate option 1142, and a staff option 1144. In response to selection of the queue option 1138, a listing of current orders for the kitchen, bar, bakery, etc. may be provided. In response to selection of the reservations option 1140, a listing of past, current, and/or future reservations may be provided. In response to selection of the communicate option 1142, one or more options for sending a message to patron depicted in the establishment interface 1130 (or elsewhere) may be provided. In response to selection of the staff option 1144, one or more options for viewing staff profiles, hours, etc. may be provided. Options for communicating with staff may also be provided.

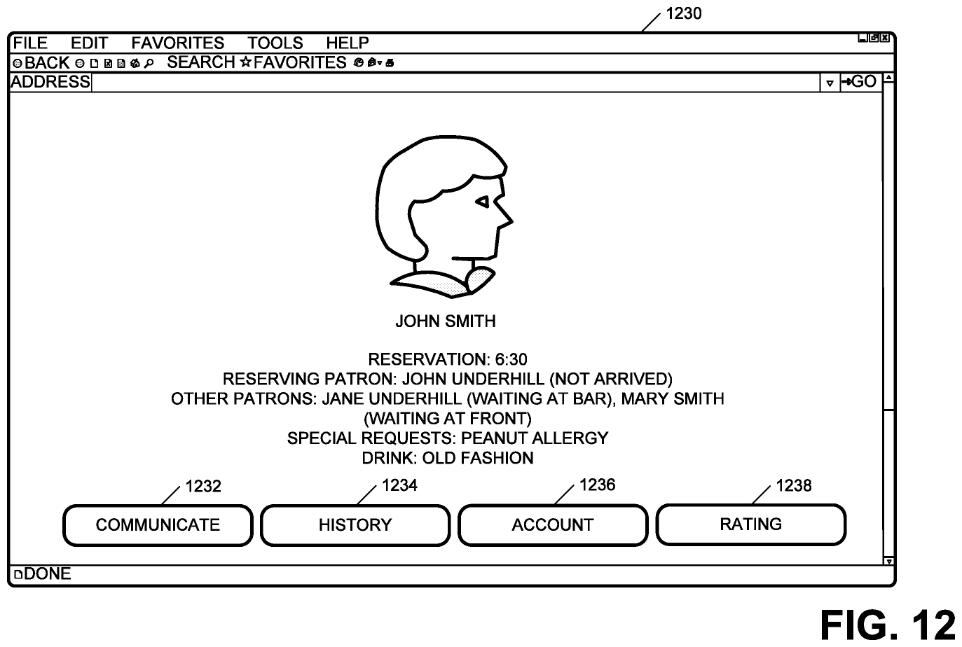

FIG. 12 depicts an establishment interface 1230 for providing information regarding a patron, according to embodiments provided herein. In response to selection of one or more of the icons 1134 provided in the establishment interface 1130, the establishment interface 1230 may be provided. An illustrated, an image of the patron may be provided, as well as information related to the reservation, party, other patrons, location of patrons, special request, favorite menu items, etc.

Also provided in the establishment interface 1230 are a communicate option 1232, a history option 1234, an account option 1236, and a rating option 1238. In response to selection of the communicate option 1232, an option and/or interface may be provided to communicate with the selected patron. In response to selection of the history option 1234, data regarding past orders, reservations, parties, etc. for the patron may be provided. In response to selection of the account option 1236, information related to the patron's account may be provided. In response to selection of the rating option 1238, an option may be provided to rate this patron, view past ratings for this patron, and/or see ratings provided by this patron.

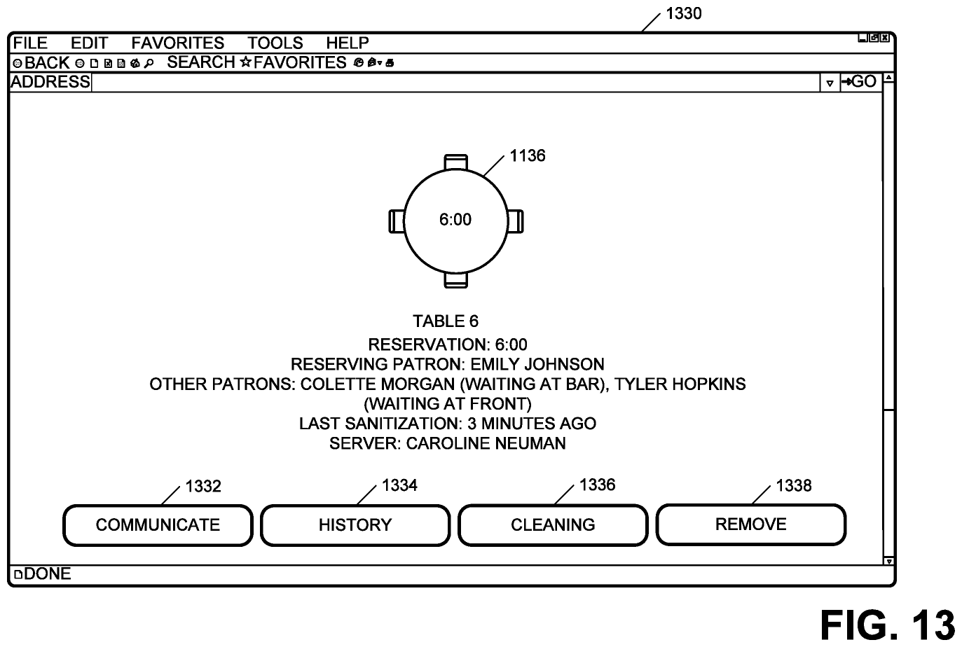

FIG. 13 depicts an establishment interface 1330 for providing information regarding a table 1136 in an establishment, according to embodiments provided herein. In response to selection of the table 1136 in the establishment interface 1130 (FIG. 11), the establishment interface 1330 may be provided. As illustrated, the establishment interface 1330 may provide a table number, a time for next reservation, a reserving patron, other patrons, a last sanitization time, and a server.

Also provided are a communicate option 1332, a history option 1334, a cleaning option 1336, and a remove option 1338. In response to selection of the communicate option 1332, a communication may be initiated with at least one person near the table and/or the server assigned to the table. In response to selection of the history option 1334, a history of usage and cleanings of the table may be provided. In response to selection of the cleaning option 1336, a notification may be sent to staff to clean the table. In response to selection of the remove option 1338, the table may be removed from service.

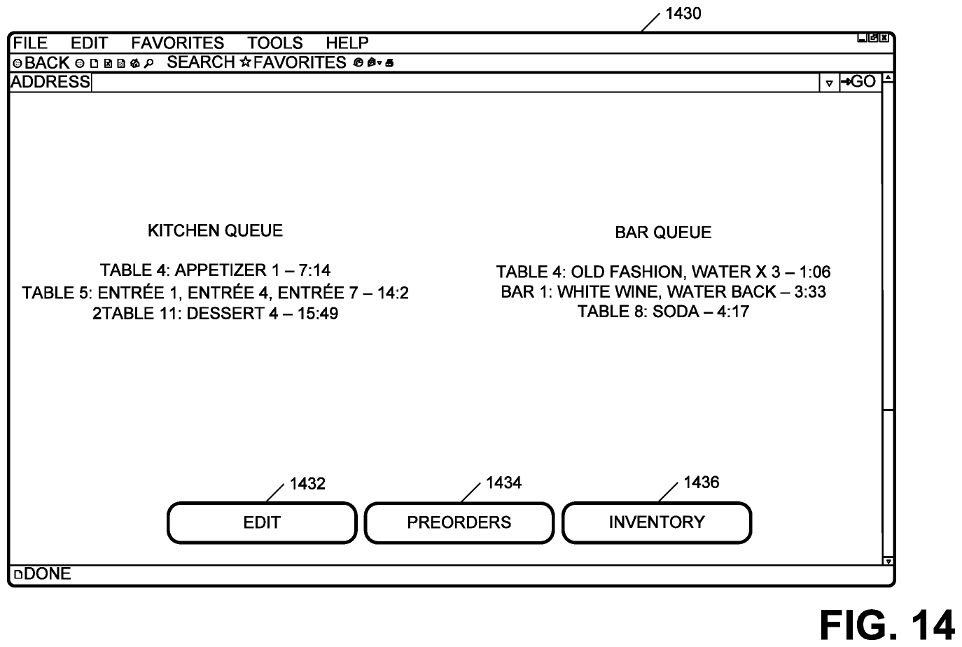

FIG. 14 depicts an establishment interface 1430 for providing information related to a kitchen queue and a bar queue, according to embodiments provided herein. In response to selection of the queue option 1138 (FIG. 11), the establishment interface 1430 may be provided. As illustrated, the establishment interface 1430 may provide a listing of orders for the kitchen, the bar, and/or elsewhere in the service establishment 200. Also provided are an edit option 1432, a preorders option 1434, and an inventory option 1436. In response to selection of the edit option 1432, a user may edit one or more of the orders that have been placed. In response to selection of the preorders option 1434, a listing of preorders (e.g., orders that have been placed before the patron has been seated for delivery when the patron is seated) may be provided. In response to selection of the inventory option 1436, a listing of current kitchen and bar inventory may be provided.

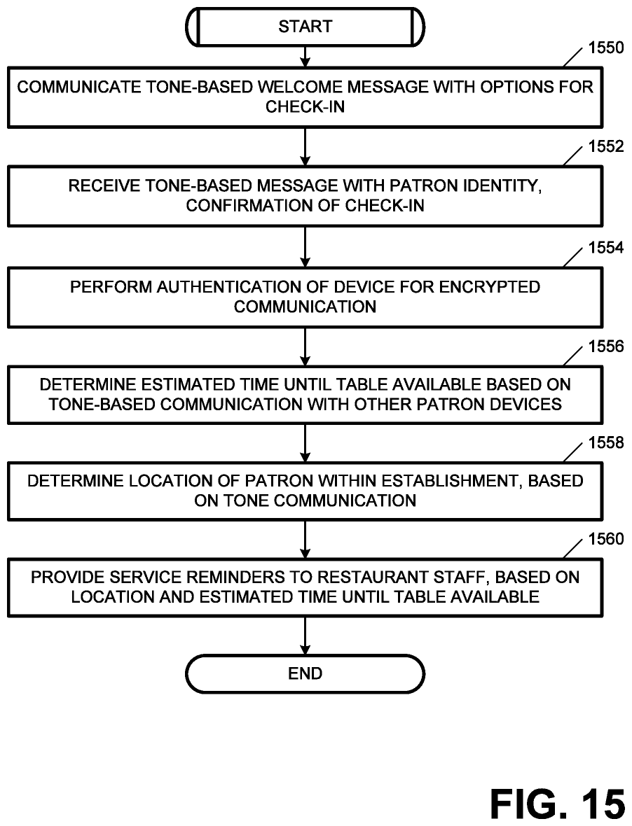

FIG. 15 depicts a flowchart for providing service reminders to restaurant staff, according to embodiments described herein. In block 1550, a tone-based welcome message with options for check-in may be communicated to the mobile device 102. In block 1552, a tone-based message may be received with a patron identity and confirmation of check-in. In block 1554, an authentication of the mobile device 102 and/or patron may be performed such that encrypted communication may be established. In some embodiments, this authentication may be a username and password, or may include other forms to authenticate that the patron is the user of the payment information and account (if established). In block 1556, an estimated time until a table is available may be determined based on tone-based communication with other patron devices. As an example, if the next available table has not yet ordered, not yet paid, or has ordered another drink, this information may be used to estimate at time that the table will be available. However, if all but two people in the party have left the establishment and all bills have been paid, the establishment may estimate that the table will be available according to those conditions.

In block 1558, a location of the patron may be determined within the establishment based on tone communications between the mobile device 102 and the tone-based communication device 104. In block 1560, service reminders may be provided to restaurant staff, based on the location and estimated time until the table is available. Specifically, an employee may receive a reminder that the patron has been waiting 30 minutes; has been served a single drink; and is waiting at the bar. The employee may additionally be provided with a reminder to make sure the patron does not need anything else and/or to provide the patron with an opportunity or reminder for pre-ordering food.

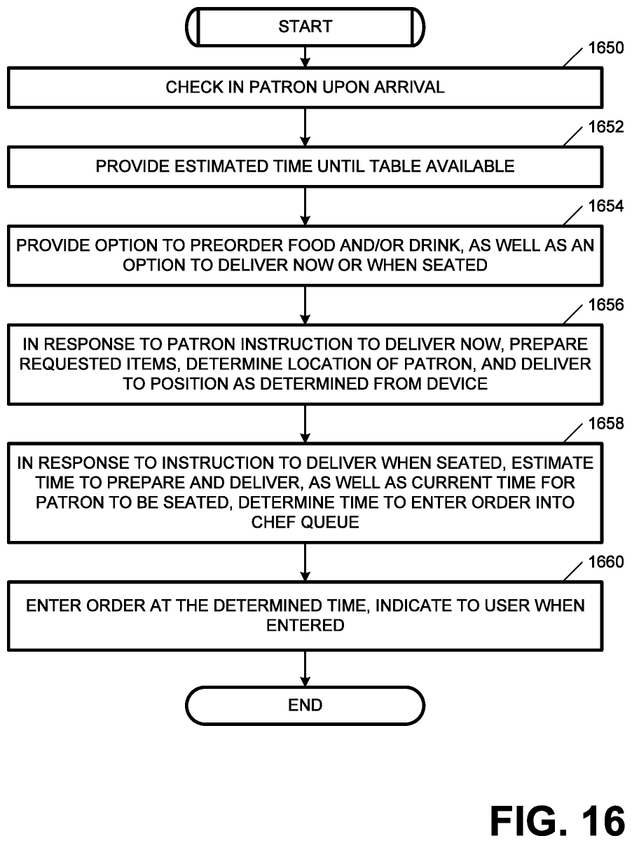

FIG. 16 depicts a flowchart for providing an option to a patron to order food, according to embodiments described herein. As illustrated in block 1650, a patron may be checked in at the establishment upon arrival. At block 1652, an estimated time until a table is available may be provided. In block 1654, an option to pre-order food and/or drink may be provided, as well as an option to deliver the order now or when seated. In block 1656, in response to patron instructions to deliver the order now, the requested items may be prepared and delivered to the patron at a position determined from communication with the mobile device 102. In block 1658, in response to an instruction to deliver when seated, a time to prepare and deliver the order may be estimated, as well as a current time for the patron to be seated. A time to enter order into the chef queue may also be determined. In block 1660, the order may be entered at the predetermined time and an indication may be provided to the user when entered.

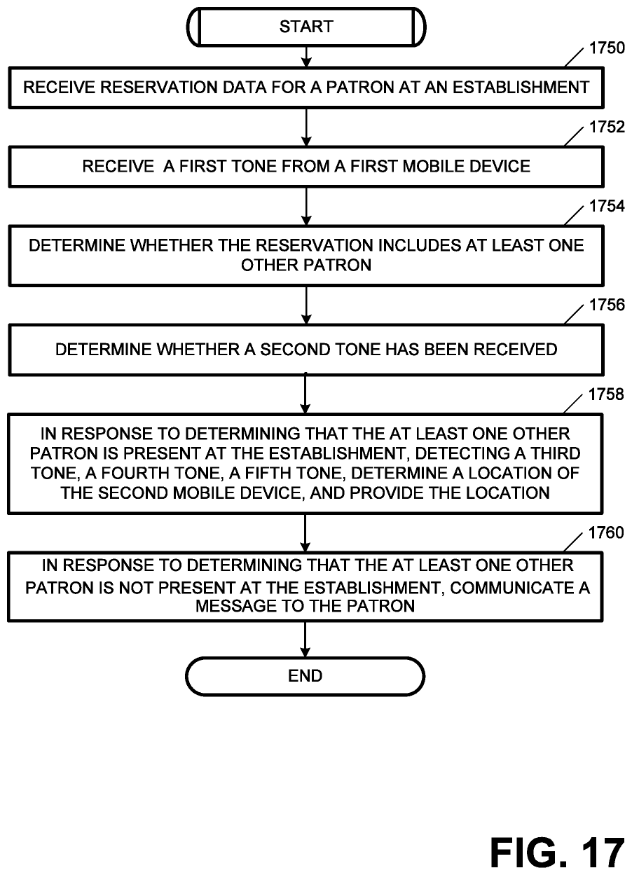

FIG. 17 depicts a flowchart for providing a tone-based service, according to embodiments provided herein. As illustrated in block 1750, reservation data for a patron at an establishment may be received. In block 1752, a first tone from a first mobile device of the patron may be received, where the first tone is non-naturally occurring and human imperceptible and where the first tone includes data that identifies the patron and the reservation. In block 1754 a determination may be made regarding whether the reservation includes at least one other patron. In block 1756, a determination may be made regarding whether a second tone has been received from a second mobile device associated with the at least one other patron indicating the at least one other patron is present at the establishment. In block 1758, in response to determining that the at least one other patron is present at the establishment: a third tone may be detected from a first tone-based communication device related to a communication sent by the second mobile device; a fourth tone may be detected from a second tone-based communication device related to the communication sent by the second mobile device; a fifth tone may be detected from a third tone-based communication device related to the communication sent by the second mobile device; a location of the second mobile device may be determined from the third tone, the fourth tone, and the fifth tone; and information related to the location of the second mobile device may be provided. In block 1760, in response to determining that the at least one other patron is not present at the establishment a message may be communicated to the patron that other members of the reservation have not yet arrived.

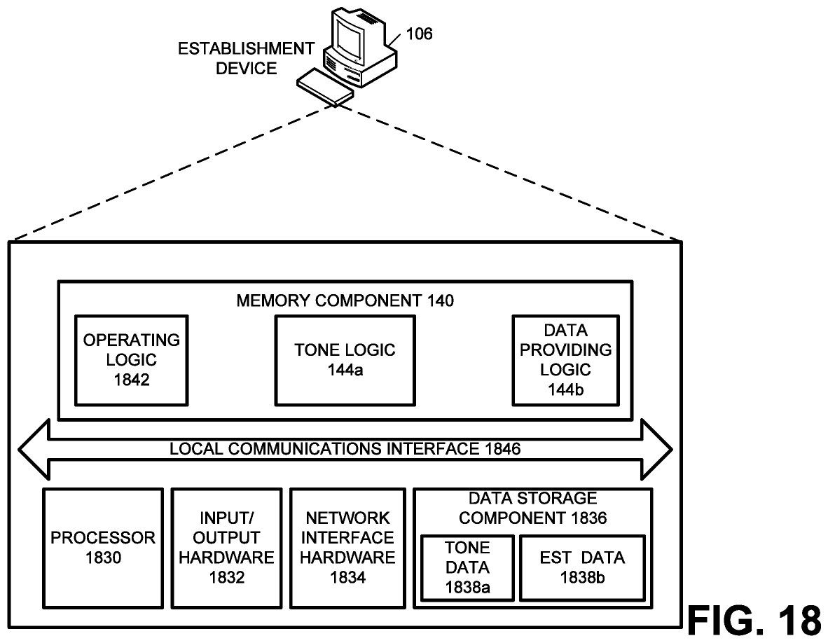

FIG. 18 depicts components of establishment device 106, according to embodiments described herein. As illustrated, the establishment device 106 includes a processor 1830, input/output hardware 1832, a network interface hardware 1834, a data storage component 1836 (which stores tone data 1838a and/or establishment data 1838b), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the establishment device 106 and/or external to the establishment device 106.

The memory component 140 may store operating logic 1842, the tone logic 144a, and the data providing logic 144b. Each of these logic components may include a plurality of different pieces of logic, each of which may be embodied as a computer program, firmware, and/or hardware, as an example. A local interface 1846 is also included in FIG. 18 and may be implemented as a bus or other communication interface to facilitate communication among the components of the remote computing device 108.

The processor 1830 may include any processing component operable to receive and execute instructions (such as from a data storage component 1836 and/or the memory component 140). As described above, the input/output hardware 1832 may include and/or be configured to interface with speakers, microphones, and/or other input/output components.

The network interface hardware 1834 may include and/or be configured for communicating with any wired or wireless networking hardware, including an antenna, a modem, a LAN port, wireless fidelity (Wi-Fi) card, WiMAX card, mobile communications hardware, and/or other hardware for communicating with other networks and/or devices. From this connection, communication may be facilitated between the remote computing device 108 and other computing devices.

The operating logic 1842 may include an operating system and/or other software for managing components of the establishment device 106. As discussed above, the tone logic 144a may reside in the memory component 140 and may be configured to cause the processor 1830 to receive commands from the mobile device 102 and/or the tone-based communication device 104 to create, edit, and/or otherwise manage tone data and content. The data providing logic 144b may be configured to cause the processor 1830 to provide the data to the tone-based communication device 104, mobile device 102, and/or establishment device 106.

It should be understood that while the components in FIG. 18 are illustrated as residing within the establishment device 106, this is merely an example. In some embodiments, one or more of the components may reside external to the establishment device 106 or within other devices, such as those depicted in FIG. 1. It should also be understood that, while the establishment device 106 is illustrated as a single device, this is also merely an example. In some embodiments, the tone logic 144a and the data providing logic 144b may reside on different computing devices.

As an example, one or more of the functionalities and/or components described herein may be provided by the mobile device 102, the tone-based communication device 104, the remote computing device 108, and/or the establishment device 106. As an example, any of these devices may have similar components as those depicted in FIG. 18. To this end, any of these devices may include logic for performing the functionality described herein.

Additionally, while the establishment device 106 is illustrated with the tone logic 144a and the data providing logic 144b as separate logical components, this is also an example. In some embodiments, a single piece of logic may provide the described functionality. It should also be understood that while the tone logic 144a and the data providing logic 144b are described herein as the logical components, this is also an example. Other components may also be included, depending on the embodiment.

As illustrated above, various embodiments for providing a tone-based service are disclosed. These embodiments may not only improve the service provided to patrons, but also improve tracking and marketing for establishments. The use of non-naturally occurring tones to this end provides a touch-free mechanism for accurately locating patrons within the establishment, as well as allowing the communication of large amounts of data individually or to a group. Additionally, as the non-naturally occurring tones may be of a higher or lower than human perception frequency, line of sight between the mobile device 102 and the tone-based communication device 104 may not be necessary.

One or more aspects of the present disclosure are described herein. A first aspect includes a method for providing a tone-based service, comprising: receiving, by a computing device, reservation data for a patron at an establishment; receiving, by the computing device, a first tone from a first mobile device of the patron, wherein the first tone is non-naturally occurring and human imperceptible, wherein the first tone includes data that identifies the patron and the reservation; determining, by the computing device, whether the reservation includes at least one other patron; determining, by the computing device, whether a second tone has been received from a second mobile device associated with the at least one other patron indicating the at least one other patron is present at the establishment; in response to determining that the at least one other patron is present at the establishment: detecting, by the computing device, a third tone from a first tone-based communication device related to a communication sent by the second mobile device; detecting, by the computing device, a fourth tone from a second tone-based communication device related to the communication sent by the second mobile device; detecting, by the computing device, a fifth tone from a third tone-based communication device related to the communication sent by the second mobile device; determining, by the computing device, a location of the second mobile device from the third tone, the fourth tone, and the fifth tone; and providing, by the computing device, information related to the location of the second mobile device; and in response to determining that the at least one other patron is not present at the establishment, communicating, by the computing device, a message to the patron that other members of the reservation have not yet arrived.

A second aspect includes the features of the first aspect, further comprising, in response to determining that the at least one other patron is present at the establishment, providing, by the computing device, data related to an order placed by the at least one other patron.

A third aspect includes the features of the first aspect and/or the second aspect, wherein the reservation is for a table at the establishment, the method further comprising: determining that the reservation may not yet be seated at the table; receiving an order from at least one of the first mobile device or the second mobile device; predicting a time to prepare the order and a time the table will be ready; and in response to predicting that the time to prepare the order is less than the time the table will be ready, providing an option to deliver the order when ready to the patron or wait until the table is ready and deliver the order to the table.

A fourth aspect includes the features of any of the first aspect through the third aspect, further comprising: determining that the reservation may be filled; determining a first location that the patron may fill the reservation; determining, from tone-based communications with the first mobile device, a second location of the first mobile device; and notifying the first mobile device that the reservation may be filled and the first location.

A fifth aspect includes the features of any of the first aspect through the fourth aspect, further comprising providing routing from the second location to the first location based on a tone-based location of the first mobile device.

A sixth aspect includes the features of any of the first aspect through the fifth aspect, further comprising: determining that the reservation has been filled; and providing, via a tone-based communication, a user interface, wherein the user interface includes at least one of the following: an option to request new accommodations, an option to refresh drinks, an option to request a server, an option to order, an option to pay, or an option to end the reservation.

A seventh aspect includes the features of any of the first aspect through the sixth aspect, further comprising: providing an option to pay a bill; and in response to receiving a selection of the option to pay, providing an option to perform at least one of the following: divide the bill, divide orders that have been placed, pay in full, or play credit card roulette.

An eighth aspect includes the features of any of the first aspect through the seventh aspect, further comprising encrypting at least one of the following: the first tone, the second tone, the third tone, the fourth tone, or the fifth tone.

A ninth aspect includes a system for providing a tone-based service, comprising: a plurality of tone-based communication devices that each include at least one of the following: a speaker or a microphone, wherein the plurality of tone based communication devices communicate data by broadcasting non-naturally occurring and human imperceptible tones; an establishment device that includes a memory component and a processor, wherein the memory component stores logic that, when executed by the processor, causes the system to perform at least the following: receive reservation data for a patron at an establishment; receive, via at least one of the plurality of tone-based communication devices, a first tone from a first mobile device of the patron, wherein the first tone includes data that identifies the patron and the reservation; determine whether the reservation includes at least one other patron; determine whether a second tone has been received, via at least one of the plurality of tone-based communication devices, from a second mobile device associated with the at least one other patron indicating the at least one other patron is present at the establishment; in response to determining that the at least one other patron is present at the establishment: receive third tones from at least three of the plurality of tone-based communication devices; calculate from the third tones, a location of the second mobile device; and provide information related to the location of the second mobile device; and in response to determining that the at least one other patron is not present at the establishment, communicate a message to the patron that other members of the reservation have not yet arrived.

A tenth aspect includes the ninth aspect, wherein the logic, when executed by the processor, causes the system, in response to determining that the at least one other patron is present at the establishment, to provide data related to an order placed by the at least one other patron.

An eleventh aspect includes the ninth and/or tenth aspect, wherein the reservation is for a table at the establishment and wherein the logic further causes the system to perform at least the following: determine that the reservation may not yet be seated at the table; receive an order from at least one of the first mobile device or the second mobile device; predict a time to prepare the order and a time the table will be ready; and in response to predicting that the time to prepare the order is less than the time the table will be ready, provide an option to deliver the order when ready to the patron or wait until the table is ready and deliver the order to the table.

A twelfth aspect includes any of a ninth aspect through the eleventh aspect, wherein the logic further causes the system to perform at least the following: determine that the reservation may be filled; determine a first location that the patron may fill the reservation; determine, from tone-based communications with the first mobile device, a second location of the first mobile device; and notify the first mobile device, via tone based communications, that the reservation may be filled and the first location.

A thirteenth aspect includes any of the ninth aspect through the twelfth aspect, wherein the logic further causes the system to provide routing from the second location to the first location based on a tone-based location of the first mobile device.

A fourteenth aspect includes any of the ninth aspect through the thirteenth aspect, wherein the logic further causes the system to perform at least the following: determine that the reservation has been filled; and provide, via a tone-based communication, a user interface, wherein the user interface includes at least one of the following: an option to request new accommodations, an option to refresh drinks, an option to request a server, an option to order, an option to pay, or an option to end the reservation.

A fifteenth aspect includes any of a ninth aspect through the fourteenth aspect, wherein the logic further causes the system to perform at least the following: providing an option to pay a bill; and in response to receiving a selection of the option to pay, provide an option to perform at least one of the following: divide the bill, divide orders that have been placed, pay in full, or play credit card roulette.

A sixteenth aspect includes any of the ninth aspect through the fifteenth aspect, wherein the logic further causes the system to encrypt at least one of the following: the first tone, the second tone, or the third tones.

A seventeenth aspect includes any of the ninth aspect through the sixteenth aspect, further comprising the first mobile device of the patron, wherein the first mobile device is configured to communicate tone-based data with the plurality of tone-based communication devices.

An eighteenth aspect includes a computing device comprising logic that when executed by a processor of the computing device, causes the computing device to perform at least the following: receive reservation data for a patron at an establishment; receive, from a first tone-based communication device, a first tone from a first mobile device of the patron, wherein the first tone includes data that identifies the patron and the reservation; determine whether the reservation includes at least one other patron; determine whether a second tone has been received from a second tone-based communication device, associated with a second mobile device of at least one other patron indicating the at least one other patron is present at the establishment; in response to determining that the at least one other patron is present at the establishment: calculate from tones created by the second mobile device, a location of the second mobile device; and provide information related to the location of the second mobile device; and in response to determining that the at least one other patron is not present at the establishment, communicate a message to the patron that other members of the reservation have not yet arrived.

A nineteenth aspect includes the eighteenth aspect wherein the logic, when executed by the processor, causes the computing device, in response to determining that the at least one other patron is present at the establishment, to provide data related to an order placed by the at least one other patron.

A twentieth aspect includes any of the eighteenth aspect and/or nineteenth aspect, wherein the reservation is for a table at the establishment and wherein the logic further causes the computing device to perform at least the following: determine that the reservation may not yet be seated at the table; receive an order from at least one of the first mobile device or the second mobile device; predict a time to prepare the order and a time the table will be ready; and in response to predicting that the time to prepare the order is less than the time the table will be ready, provide an option to deliver the order when ready to the patron or wait until the table is ready and deliver the order to the table.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for providing a tone-based service. It should also be understood that these embodiments are merely exemplary and are not intended to limit the scope of this disclosure.

What is claimed is:

1. A method for providing a tone-based service, comprising:
receiving, by a computing device, reservation data for a patron at an establishment;
receiving, by the computing device, a first tone from a first mobile device of the patron, wherein the first tone is non-naturally occurring and human imperceptible, wherein the first tone includes data that identifies the patron and the reservation;
determining, by the computing device, whether the reservation includes at least one other patron;
determining, by the computing device, whether a second tone has been received from a second mobile device associated with the at least one other patron indicating the at least one other patron is present at the establishment;
in response to determining that the at least one other patron is present at the establishment:
detecting, by the computing device, a third tone from a first tone-based communication device related to a communication sent by the second mobile device;
detecting, by the computing device, a fourth tone from a second tone-based communication device related to the communication sent by the second mobile device;
detecting, by the computing device, a fifth tone from a third tone-based communication device related to the communication sent by the second mobile device;
determining, by the computing device, a location of the second mobile device from the third tone, the fourth tone, and the fifth tone; and
providing, by the computing device, information related to the location of the second mobile device; and
in response to determining that the at least one other patron is not present at the establishment, communicating, by the computing device, a message to the patron that other members of the reservation have not yet arrived.

2. The method of claim 1 further comprising, in response to determining that the at least one other patron is present at the establishment, providing, by the computing device, data related to an order placed by the at least one other patron.

3. The method of claim 1, wherein the reservation is for a table at the establishment, the method further comprising:
determining that the reservation may not yet be seated at the table;
receiving an order from at least one of the first mobile device or the second mobile device;
predicting a time to prepare the order and a time the table will be ready; and
in response to predicting that the time to prepare the order is less than the time the table will be ready, providing an option to deliver the order when ready to the patron or wait until the table is ready and deliver the order to the table.

4. The method of claim 1, further comprising:
determining that the reservation may be filled;
determining a first location that the patron may fill the reservation;
determining, from tone-based communications with the first mobile device, a second location of the first mobile device; and
notifying the first mobile device that the reservation may be filled and the first location.

5. The method of claim 4, further comprising providing routing from the second location to the first location based on a tone-based location of the first mobile device.

6. The method of claim 1 further comprising:
determining that the reservation has been filled; and
providing, via a tone-based communication, a user interface, wherein the user interface includes at least one of the following: an option to request new accommodations, an option to refresh drinks, an option to request a server, an option to order, an option to pay, or an option to end the reservation.

7. The method of claim 1, further comprising:
providing an option to pay a bill; and
in response to receiving a selection of the option to pay, providing an option to perform at least one of the following: divide the bill, divide orders that have been placed, pay in full, or play credit card roulette.

8. The method of claim 1, further comprising encrypting at least one of the following: the first tone, the second tone, the third tone, the fourth tone, or the fifth tone.

9. A system for providing a tone-based service, comprising:
a plurality of tone-based communication devices that each include at least one of the following: a speaker or a microphone, wherein the plurality of tone based communication devices communicate data by broadcasting non-naturally occurring and human imperceptible tones;
an establishment device that includes a memory component and a processor, wherein the memory component stores logic that, when executed by the processor, causes the system to perform at least the following:
receive reservation data for a patron at an establishment;
receive, via at least one of the plurality of tone-based communication devices, a first tone from a first mobile device of the patron, wherein the first tone includes data that identifies the patron and the reservation;
determine whether the reservation includes at least one other patron;
determine whether a second tone has been received, via at least one of the plurality of tone-based communication devices, from a second mobile device associated with the at least one other patron indicating the at least one other patron is present at the establishment;
in response to determining that the at least one other patron is present at the establishment:
receive third tones from at least three of the plurality of tone-based communication devices;
calculate from the third tones, a location of the second mobile device; and
provide information related to the location of the second mobile device; and
in response to determining that the at least one other patron is not present at the establishment, communicate a message to the patron that other members of the reservation have not yet arrived.

10. The system of claim 9, wherein the logic, when executed by the processor, causes the system, in response to determining that the at least one other patron is present at the establishment, to provide data related to an order placed by the at least one other patron.

11. The system of claim 9, wherein the reservation is for a table at the establishment and wherein the logic further causes the system to perform at least the following:
determine that the reservation may not yet be seated at the table;
receive an order from at least one of the first mobile device or the second mobile device;
predict a time to prepare the order and a time the table will be ready; and
in response to predicting that the time to prepare the order is less than the time the table will be ready, provide an option to deliver the order when ready to the patron or wait until the table is ready and deliver the order to the table.

12. The system of claim 9, wherein the logic further causes the system to perform at least the following:
determine that the reservation may be filled;
determine a first location that the patron may fill the reservation;
determine, from tone-based communications with the first mobile device, a second location of the first mobile device; and
notify the first mobile device, via tone based communications, that the reservation may be filled and the first location.

13. The system of claim 12, wherein the logic further causes the system to provide routing from the second location to the first location based on a tone-based location of the first mobile device.

14. The system of claim 9, wherein the logic further causes the system to perform at least the following:
determine that the reservation has been filled; and
provide, via a tone-based communication, a user interface, wherein the user interface includes at least one of the following: an option to request new accommodations, an option to refresh drinks, an option to request a server, an option to order, an option to pay, or an option to end the reservation.

15. The system of claim 9, wherein the logic further causes the system to perform at least the following:
providing an option to pay a bill; and
in response to receiving a selection of the option to pay, provide an option to perform at least one of the following: divide the bill, divide orders that have been placed, pay in full, or play credit card roulette.

16. The system of claim 9, wherein the logic further causes the system to encrypt at least one of the following: the first tone, the second tone, or the third tones.

17. The system of claim 9, further comprising the first mobile device of the patron, wherein the first mobile device is configured to communicate tone-based data with the plurality of tone-based communication devices.

18. A computing device comprising logic that when executed by a processor of the computing device, causes the computing device to perform at least the following:
receive reservation data for a patron at an establishment;
receive, from a first tone-based communication device, a first tone from a first mobile device of the patron, wherein the first tone includes data that identifies the patron and the reservation;
determine whether the reservation includes at least one other patron;
determine whether a second tone has been received from a second tone-based communication device, associated with a second mobile device of at least one other patron indicating the at least one other patron is present at the establishment;
in response to determining that the at least one other patron is present at the establishment:
calculate from tones created by the second mobile device, a location of the second mobile device; and
provide information related to the location of the second mobile device; and
in response to determining that the at least one other patron is not present at the establishment, communicate a message to the patron that other members of the reservation have not yet arrived.

19. The computing device of claim 18, wherein the logic, when executed by the processor, causes the computing device, in response to determining that the at least one other patron is present at the establishment, to provide data related to an order placed by the at least one other patron.

20. The computing device of claim 18, wherein the reservation is for a table at the establishment and wherein the logic further causes the computing device to perform at least the following:
determine that the reservation may not yet be seated at the table;
receive an order from at least one of the first mobile device or the second mobile device;
predict a time to prepare the order and a time the table will be ready; and
in response to predicting that the time to prepare the order is less than the time the table will be ready, provide an option to deliver the order when ready to the patron or wait until the table is ready and deliver the order to the table.
